(19) United States
(12) Patent Application Publication
(10) Pub. No.: US 2009/0122088 A1
(43) Pub. Date: May 14, 2009

(54) PLASMA DISPLAY DEVICE AND DRIVING METHOD THEREOF

(76) Inventor: Jong-Wook Kim, Suwon-si (KR)

Correspondence Address: CHRISTIE, PARKER & HALE, LLP, PO BOX 7068, PASADENA, CA, 91109-7068, US

(21) Appl. No.: 12/263,925

(22) Filed: Nov. 3, 2008

(30) Foreign Application Priority Data
Nov. 14, 2007 (KR) 10-2007-0116130

(51) Int. Cl. G09G 5/10; G09G 3/28

(52) U.S. Cl. 345/690; 345/60

(57) ABSTRACT

A plasma display device in which a single frame of an inputted video signal is divided into a plurality of subfields to display gray levels according to a combination of the subfields. The highest gray level among the gray levels of an image of a single frame is detected by using the inputted single frame of video signal. When the highest gray level is lower than a first gray level, a first number of subfields among the plurality of subfields are set with the same weight value. When the highest gray level is lower than a second gray level that is higher than the first gray level, a second number of subfields that is smaller than the first number, among the plurality of subfields, are set with the same weight value to display the gray levels of the single frame.

### CROSS-REFERENCE TO RELATED APPLICATION

This application claims priority to and the benefit of Korean Patent Application No. 10-2007-0116130, filed in the Korean Intellectual Property Office on Nov. 14, 2007, the entire content of which is incorporated herein by reference.

### BACKGROUND OF THE INVENTION

(a) Field of the Invention

The present invention relates to a plasma display device and a driving method thereof.

(b) Description of the Related Art

Recently, flat panel display devices such as a liquid crystal display (LCD), a field emission display (FED), a plasma display panel (PDP), and the like, have been actively developed. Among the flat panel display devices, the plasma display device has higher luminance, higher luminous efficiency, and a wider viewing angle, compared with other flat panel display devices.

In the plasma display device, inputted video signal data of a single frame is divided into a plurality of subfields, and the subfields are time-divided to represent gray levels. In a case where the video signal data of a single frame is divided into the plurality of subfields, and gray levels, e.g., gray levels 7 and 8, are represented according to an ON/OFF operation of the respective subfields, a gray scale inversion phenomenon may occur in which the luminance of gray level 7 is brighter than gray level 8 due to the difference in the number of the illuminated subfields.

Thus, in order to address such problem, gray levels have been implemented such that, for gray levels having a smaller number of illuminated subfields than lower gray levels, adjacent gray levels are dithered. In such a case of performing dithering to reduce the difference in the number of illuminated subfields to implement gray levels, linearity of the gray levels can be improved.

However, when gray levels of a displayed image are inputted as lower gray levels, the dithered continuous gray levels are displayed, causing dithering noise at the lower gray levels expressed to be brighter than the luminance corresponding to the gray levels desired to be originally represented.

The above information disclosed in this Background section is only for enhancement of understanding of the background of the invention, and therefore it may contain information that does not form the prior art that is already known in this country to a person of ordinary skill in the art.

### SUMMARY OF THE INVENTION

Embodiments of the present invention provide a plasma display device and a driving method thereof for preventing or reducing dithering noise from being generated at lower gray scales.

An embodiment of the present invention provides a method for driving a plasma display device in which a single frame of an image of an inputted video is divided into a plurality of subfields to display gray levels according to a combination of the subfields. The method includes: detecting a highest gray level of the gray levels of the single frame of the image by using the inputted video signal; setting a first number of subfields among the plurality of subfields when the highest gray level is a first gray level or lower, the first number of subfields having the same weight value; setting a second number of subfields among the plurality of subfields when the highest gray level is a second gray level or lower but higher than the first gray level, and the second number is smaller than the first number. The second number of subfields have the same weight value. Displaying the gray levels of the image is by utilizing the plurality of subfields.

Another embodiment of the present invention provides a plasma display device. The plasma display device includes: a plasma display panel including a plurality of first and second electrodes and a plurality of third electrodes crossing the plurality of first and second electrodes; a controller for detecting a highest gray level of an image displayed in a single frame by using a video signal inputted during the single frame and selecting a P number of subfields to display the image among a Q number of subfields according to the highest gray level; and a driver for driving the plurality of first and second electrodes and the plurality of third electrodes according to a control signal generated by the controller. The P number is smaller than the Q number.

Yet another embodiment of the present invention provides a plasma display device. The plasma display device includes: a first electrode extending in a direction; a second electrode extending in the same direction as the first electrode; a controller for detecting a highest gray level of an image displayed during a single frame by using a video signal inputted during the single frame, setting an N1 number of subfields among a plurality of subfields, the N1 number of subfields having a same weight value, when the highest gray level is lower than a first gray level, and setting an N2 number of subfields that is smaller than the N1 number among the plurality of subfields, the N2 number of subfields having the same weight value, when the highest gray level is lower than a second gray level and higher than the first gray level; and a driver for applying sustain pulses corresponding to the weight value of the plurality of subfields and driving the first and second electrodes. A third gray level, a fourth gray level that is lower than the third gray level, and a fifth gray level that is higher than the third gray level are mapped to the plurality of subfields. When the number of subfields illuminated corresponding to the third gray level is smaller than the number of subfields illuminated corresponding to the fourth gray level, the controller applies dithering to the fourth gray level and the fifth gray level to display the third gray level.

As described above, picture quality can be improved by minimizing dithering noise in an image expressed with a low gray level, and luminance quality of the image expressed with a high gray level can be maintained.

In addition, a luminance flickering phenomenon can be reduced by using a fixed number of subfields in the process of reducing dithering noise.

### BRIEF DESCRIPTION OF THE DRAWINGS

FIG. 1 is a schematic top plan view of a plasma display device according to an exemplary embodiment of the present invention.

FIG. 2 is a table of weight values of subfields according to an exemplary embodiment of the present invention.

FIG. 3 is a look-up table of gray levels using weight values of the subfields of FIG. 2.

FIG. 4 is a schematic block diagram showing a controller of the plasma display device according to an exemplary embodiment of the present invention.

FIG. 5 is a look-up table set in a subfield setting unit in FIG. 4.

FIG. 6 is a flow chart illustrating a process of a method for preventing dithering noise from being generated at lower gray levels according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements.

The plasma display device and an image processing method thereof according to an exemplary embodiment of the present invention will now be described with reference to the accompanying drawings.

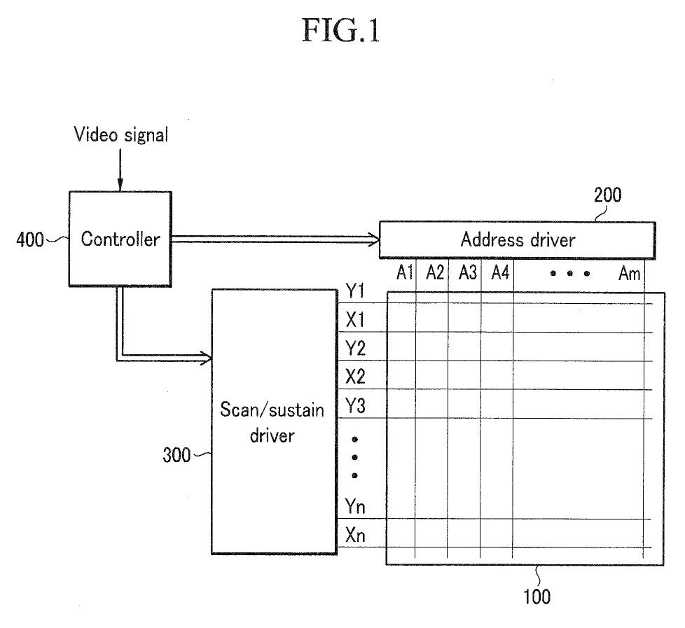

FIG. 1 is a schematic top plan view of a plasma display device according to an exemplary embodiment of the present invention.

As shown in FIG. 1, the plasma display device according to an exemplary embodiment of the present invention includes a plasma display panel 100, an address driver 200, a scan/sustain driver 300, and a controller 400.

The plasma display panel 100 includes a plurality of address electrodes A1 to Am extending in a column direction, and a plurality of scan electrodes Y1 to Yn and sustain electrodes X1 to Xn extending in a row direction. The address driver 200 receives an address driving control signal from the controller 400, and applies a display data signal for selecting discharge cells to be displayed to the address electrodes A1 to Am. The scan/sustain driver 300 receives a control signal from the controller 400, and alternately applies sustain pulses to the scan electrodes Y1 to Yn and the sustain electrodes X1 to Xn to perform sustain discharges with respect to the selected discharge cells.

The controller 400 receives a video signal and a synchronous signal from an external source, divides a single frame into a plurality of subfields each having a weight value, with each subfield being divided into a reset period, an address period, and a sustain period, generates a control signal for driving the plasma display device, and supplies the control signal to the address driver 200 and the scan/sustain driver 300. The controller 400 displays a video signal of certain gray levels among the inputted video signals through dithering by using upper gray levels and lower gray levels. In addition, the controller 400 detects the highest gray level among all the gray levels of the image displayed during a single frame by utilizing the inputted video signal, sets subfields according to the highest gray level, and removes dithering noise at a lower gray level region. Namely, with the number of subfields fixed, the controller 400 changes weight values of the subfields to change an illumination pattern at the lower gray level region according to the highest gray level of the image displayed during the single frame. The controller 400 allocates sustain pulses by a number proportional to the weight values of the subfields to the respective subfields.

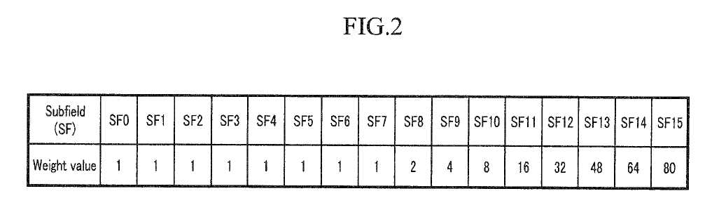

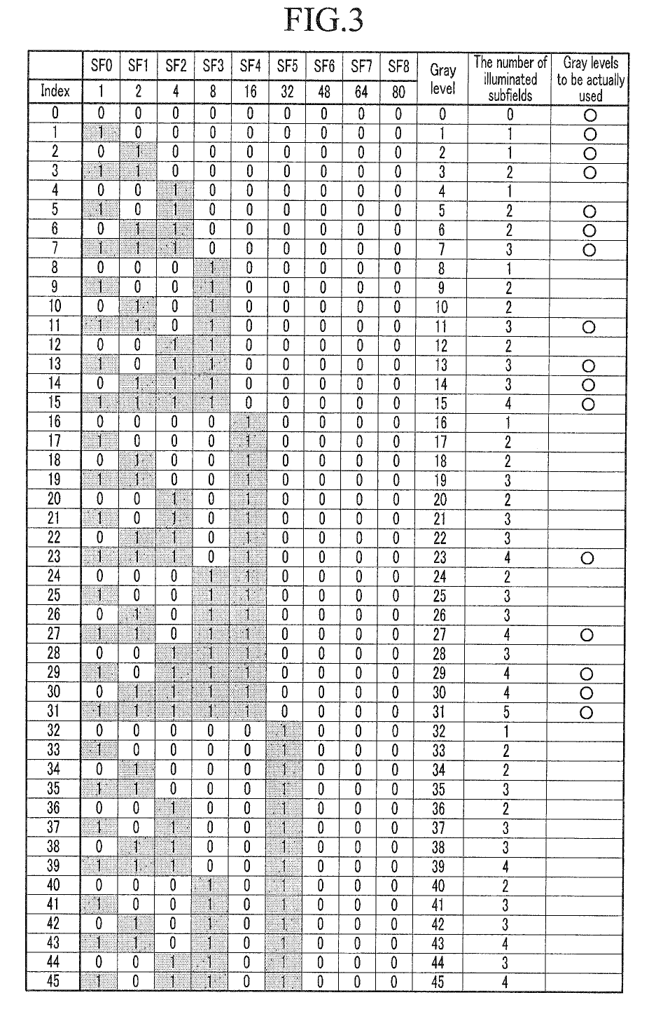

The method of representing gray levels according to an exemplary embodiment of the present invention will now be described with reference to FIGS. 2 and 3.

FIG. 2 is a table of weight values of subfields according to an exemplary embodiment of the present invention, and FIG. 3 is a look-up table of gray levels utilizing the weight values of the subfields of FIG. 2.

As shown in FIG. 2, the inputted video signal data of one frame is divided into a plurality of subfields, and the subfields are time-divided to display gray levels. Each subfield includes a reset period, an address period, and a sustain period in terms of a temporal operation change. The reset period is a period during which a state of each cell is initialized to smoothly perform an address operation in the cells, and the address period is a period during which an operation of accumulating wall charges is performed by applying address voltages to turned-on cells (addressed cells) to select cells that are to be turned on and cells that are not to be turned on in the plasma display panel. The sustain period is a period during which sustain discharge pulses are applied to perform discharging to actually display an image by the addressed cells.

FIG. 2 shows an embodiment where a single frame is composed of nine subfields among sixteen subfields (SF0 to SF15) to implement a maximum of 256 gray levels. Each of the subfields SF0 to SF15 includes the reset period (not shown), the address period (not shown), and the sustain period (not shown); and the ratios of the weight values, namely, the ratios of lengths of the sustain periods of the subfields SF0 to SF15, are 1:1:1:1:1:1:1:1:2:4:8:16:32:48:64:80.

The controller 400 determines nine subfields to be selected to display gray levels among the plurality of subfields SF0 to SF15 according to the maximum gray levels of the inputted video signal. For example, when the controller 400 selects the rear nine subfields (SF7 to SF15) among the sixteen subfields SF0 to SF15, an image of a maximum 256 gray levels may be displayed; and when the controller 400 selects the front nine subfields (SF0 to SF8), an image of a maximum 11 gray levels may be displayed.

As shown in FIG. 3, as an example, the subfields SF7 to SF15 are selected to display gray levels, when the gray levels 7 and 8 are expressed, a gray scale inversion phenomenon may occur in which the luminance of the gray level 7 may be brighter than the gray level 8 because of the difference in the number of illuminated subfields. In the case of the gray level 7, three subfields are illuminated, while in the case of the gray level 8, one subfield is illuminated.

Thus, in consideration of the occurrence of the gray scale inversion phenomenon due to the difference of the number of the illuminated subfields, in the embodiment of the present invention, dithering is performed to reduce the difference of the number of the illuminated subfields between gray levels in which the gray scale inversion phenomenon may occur.

For example, when the number of illuminated subfields representing a gray level N₁ is greater than the number of illuminated subfields representing a gray level (N₁+1), the controller 400 applies dithering to the gray levels N₁ and M₁ to express the gray level (N₁+1). In this case, the gray level M₁ is the lowest gray level among gray levels of subfields that have the same or greater number of illuminated subfields than that of the gray level N₁ among gray levels greater than the gray level N₁. Likewise, the controller 400 applies dithering to the gray level N₁ and the gray level M₁ to represent the gray level (N₁+1) to the gray level (M₁−1).

For example, gray level 7 has three illuminated subfields, and gray levels 8, 9, and 10 have one, two, and two subfields, respectively. Thus, the number of illuminated subfields of gray levels 8, 9, and 10 is less by one or more than the number of illuminated subfields of gray level 7, and the number of illuminated subfields of gray level 11 is the same as the number of illuminated subfields of gray level 7. Then, the controller 400 applies dithering to gray levels 11 and 7 to display them, not outputting gray levels 8, 9, and 10 as is. Thus, when the gray levels are implemented by performing dithering to reduce the difference in the number of illuminated subfields, linearity of the gray levels can be improved. However, when a video signal has lower gray levels such as the gray levels 8, 9, and 10, the respective converted values of the gray levels 8 to 10 implemented after being dithered are expressed to be brighter than the luminance corresponding to the gray levels to be originally expressed, causing dithering noise at the lower gray levels.

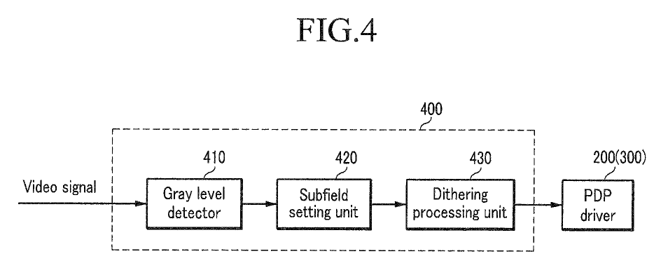

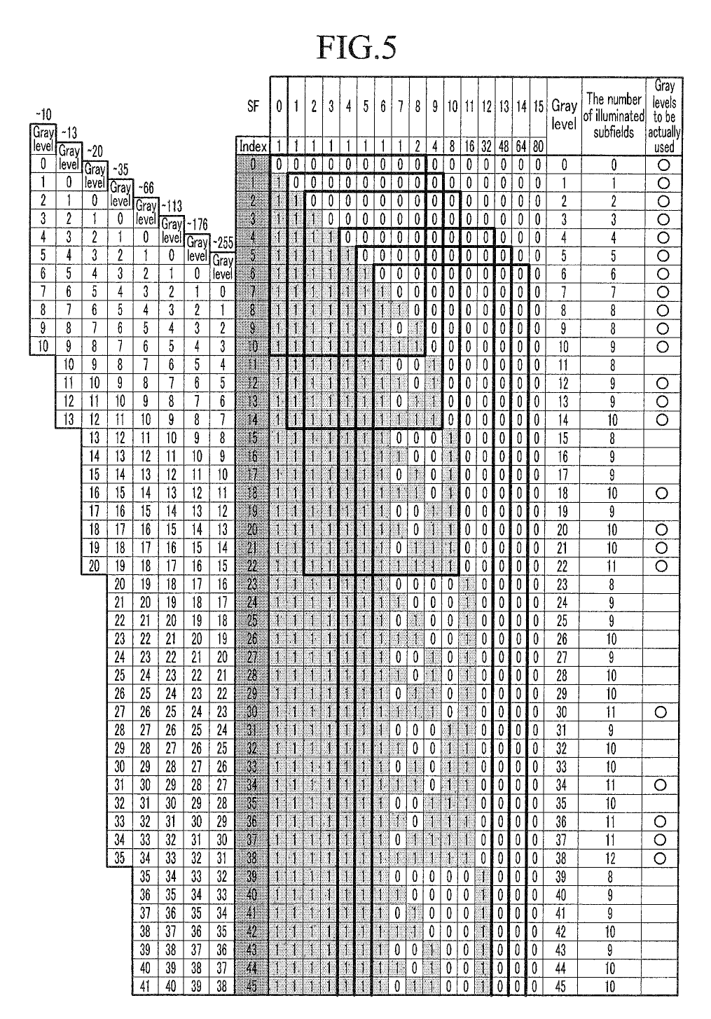

The method for preventing dithering noise from being generated at the lower gray levels according to an embodiment of the present invention will now be described with reference to FIGS. 4 and 5.

FIG. 4 is a schematic block diagram showing a controller of the plasma display device according to an exemplary embodiment of the present invention, and FIG. 5 is a view showing a look-up table set in a subfield setting unit in FIG. 4.

As shown in FIG. 4, the controller 400 of the plasma display device according to the embodiment of the present invention includes a gray level detector 410, a subfield setting unit 420, and a dithering processing unit 430.

The gray level detector 410 detects the highest gray level of the entire gray levels of an image displayed during a single frame of an inputted video signal.

The subfield setting unit 420 selects a number of subfields (e.g., a predetermined number of subfields) to be used, e.g., nine subfields, from the plurality of subfields SF0 to SF15 according to the highest gray level detected by the gray scale detector 410. In this embodiment of the present invention, the number of selected subfields is always the same regardless of the highest gray level. The method for setting subfields according to the highest gray level of the image will now be described with reference to FIG. 5.

As shown in FIG. 5, when gray levels of an image range from 177 to 255, the subfield setting unit 420 selects the nine subfields SF7 to SF15 positioned at the relatively rear portion of the sixteen subfields SF0 to SF15.

When gray levels of an image range from 114 to 176, the subfield setting unit 420 selects the subfield SF6 with a weight value 1 instead of the subfield SF15 with a weight value 80 that is not used in representing the gray levels of 176 or lower among the subfields used for representing the highest gray level 255 of the image. Namely, the subfield setting unit 420 selects the nine subfields SF6 to SF14, excluding the final subfield SF15.

When gray levels of an image range from 67 to 113, the subfield setting unit 420 selects the subfield SF5 with a weight value 1 instead of the subfield SF14 with a weight value 64 that is not used in representing the gray levels of 113 or lower among the subfields used for representing the highest gray level 176 of the image. Namely, the subfield setting unit 420 selects nine subfields SF5 to SF13, excluding the final subfield SF14.

In the same manner, the subfield setting unit 430 selects subfields each with a weight value 1 by the number of non-selected subfields, rather than selecting the subfields that are not used to represent the highest gray level, respectively, when gray levels of an image range from 36 to 66, from 21 to 35, from 14 to 20, from 11 to 13, and from 0 to 10. In other words, when the gray levels of an image range from 36 to 66, the subfield setting unit 420 selects the nine subfields SF4 to SF12 excluding the final subfield SF13 that is not used to represent gray levels of 66 or lower. When the gray levels of an image range from 21 to 35, the subfield setting unit 420 selects the nine subfields SF3 to SF11 excluding the final subfield SF12 that is not used to represent gray levels of 35 or lower. When the gray levels of an image range from 14 to 20, the subfield setting unit 420 selects the nine subfields SF2 to SF10 excluding the final subfield SF11 that is not used to represent gray levels of 20 or lower. When the gray levels of an image range from 11 to 13, the subfield setting unit 420 selects the nine subfields SF1 to SF9 excluding the final subfield SF10 that is not used to represent gray levels of 13 and lower. When the gray levels of an image range from 0 to 10, the subfield setting unit 420 selects the nine subfields SF0 to SF8 excluding the final subfield SF9 that is not used to represent gray levels of 10 or lower.

In this manner, when gray levels of an image displayed during a single frame range from N to M, the subfield setting unit 420 according to the embodiment of the present invention does not select a subfield that is not used to represent the highest gray level M or lower gray levels but select subfields each having a weight value 1 by the number of the non-selected subfields. Then, in the case of an image displayed with lower gray levels, the gray levels are represented in a continuous illumination pattern, whereby the image are displayed with the gray levels desired to be originally represented, thus preventing a dithering noise phenomenon that is otherwise generated at the lower gray levels.

With reference to FIGS. 4 and 5, the dithering processing unit 430 determines whether there is any gray level where a gray scale inversion phenomenon occurs among the gray levels of an image displayed during a single frame. Namely, if a gray scale inversion phenomenon occurs in a gray level among the gray levels of the image displayed during the single frame, the dithering processing unit 430 performs dithering on the gray level where the gray scale inversion phenomenon occurs. If no gray scale inversion phenomenon occurs in any gray levels of the image displayed during the single frame, the dithering processing unit 430 does not perform dithering but outputs the gray levels to display the image with the gray levels without dithering.

In this manner, the controller 400 according to the exemplary embodiment of the present invention selects the subfields according to the highest gray level to represent the gray levels without dithering noise, which is generated at lower gray levels, on the plasma display panel 100, determines the number of sustain pulses of each subfield that are proportional to the weight values of the selected subfields, and transmits the same to the scan/sustain driver 300.

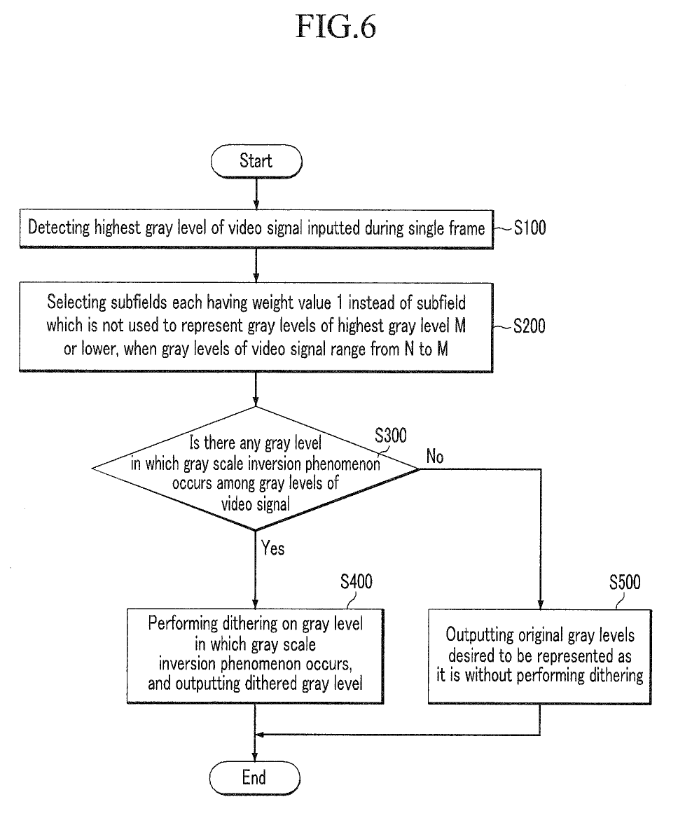

FIG. 6 is a flow chart illustrating the process of a method for preventing dithering noise from being generated at lower gray levels according to an exemplary embodiment of the present invention.

First, the gray level detector 410 detects the highest gray level of all the gray levels of an image displayed in a single frame of an inputted video signal (S100).

When gray levels of the video signal displayed during a single frame range from N to M, the subfield setting unit 420 does not select a subfield that is not used to represent the highest gray level M and lower gray levels but selects subfields each having a weight value 1 by the number of non-selected subfields.

The dithering processing unit 430 determines whether there is any gray level in which a gray scale inversion phenomenon occurs among the gray levels of the image displayed in the single frame (S300).

If there is a gray level in which the gray scale inversion phenomenon occurs among the gray levels of the image displayed in the single frame, the dithering processing unit 430 performs dithering on the gray level in which the gray scale inversion phenomenon occurs, and outputs the same (S400). If there is no gray level in which the gray scale inversion phenomenon occurs among the gray levels of the image displayed in the single frame, the dithering processing unit 430 outputs the gray levels desired to be represented as is without performing dithering (S500).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A method for driving a plasma display device in which a single frame of an image of an inputted video signal is divided into a plurality of subfields to display gray levels according to a combination of the subfields, the method comprising:
detecting a highest gray level of the gray levels of the single frame of the image by using the inputted video signal;
setting a first number of subfields among the plurality of subfields when the highest gray level is a first gray level or lower, the first number of subfields having the same weight value;
setting a second number of subfields among the plurality of subfields when the highest gray level is a second gray level or lower but higher than the first gray level, the second number being smaller than the first number, the second number of subfields having the same weight value; and
displaying gray levels of the image by utilizing the plurality of subfields.

2. The method of claim 1, wherein a third gray level, a fourth gray level that is lower than the third gray level, and a fifth gray level that is higher than the third gray level are mapped to the plurality of subfields, and
wherein when the number of subfields illuminated corresponding to the third gray level is smaller than the number of subfields illuminated corresponding to the fourth gray level and to the fifth gray level, dithering is applied to the fourth gray level and the fifth gray level to display the third gray level.

3. The method of claim 1, wherein when the number of subfields illuminated corresponding to a gray level (N+1) mapped to the plurality of subfields is smaller than the number of subfields illuminated corresponding to a gray level N mapped to the plurality of subfields, said displaying the gray levels of the image comprises:
applying dithering to the gray level N and a gray level M that is higher than the gray level N to display gray level (N+1) to gray level (M−1),
wherein the gray level M is the lowest gray level of gray levels that have the same or greater number of illuminated subfields than that of the gray level N, said gray levels being higher than the gray level N.

4. The method of claim 1, wherein the same weight value is 1.

5. The method of claim 4, wherein the number of the plurality of subfields is fixed.

6. A plasma display device comprising:
a plasma display panel comprising a plurality of first and second electrodes and a plurality of third electrodes crossing the plurality of first and second electrodes;
a controller for detecting a highest gray level of an image displayed in a single frame by using a video signal inputted during the single frame and selecting a P number of subfields to display the image among a Q number of subfields according to the highest gray level; and
a driver for driving the plurality of first and second electrodes and the plurality of third electrodes according to a control signal generated by the controller,
wherein the P number is smaller than the Q number.

7. The device of claim 6, wherein the P number is fixed.

8. The device of claim 6, wherein weight values of an L number of subfields among the Q number of subfields are the same.

9. The device of claim 8, wherein when the highest gray level is lower than a first gray level, the controller allocates an L1 number of subfields among the L number of subfields to the P number of subfields, and when the highest gray level is higher than the first gray level but lower than a second gray level, the controller allocates an L2 number of subfields that is smaller than the L1 number, among the L number of subfields to the P number of subfields.

10. The device of claim 9, wherein the weight values of the L number of subfields among the P number of subfields are the smallest.

11. The device of claim 6, wherein a third gray level, a fourth gray level that is lower than the third gray level, and a fifth gray level that is higher than the third gray level are mapped to the Q number of subfields, and
wherein when the number of subfields illuminated corresponding to the third gray level is smaller than the number of subfields illuminated corresponding to the fourth gray level and that of the fifth gray level, the controller applies dithering to the fourth gray level and the fifth gray level to display the third gray level.

12. The device of claim 6, wherein when the number of subfields illuminated corresponding to a gray level (R+1) mapped to the Q number of subfields is smaller than the number of subfields illuminated corresponding to a gray level R mapped to the Q number of subfields, the controller applies dithering to the gray level R and a gray level W to display a video signal of the gray level (R+1) to a gray level (W−1),
wherein the gray level W is the lowest gray level of gray levels that have the same or greater number of illuminated subfields than that of the gray level R, said gray levels being higher than the gray level R.

13. A plasma display device comprising:
a first electrode extending in a direction;
a second electrode extending in the same direction as the first electrode;
a controller for detecting a highest gray level of an image displayed during a single frame by using a video signal inputted during the single frame, setting an N1 number of subfields among a plurality of subfields, the N1 number of subfields having a same weight value, when the highest gray level is lower than a first gray level, and setting an N2 number of subfields that is smaller than the N1 number among the plurality of subfields, the N2 number of subfields having the same weight value, when the highest gray level is lower than a second gray level and higher than the first gray level; and
a driver for applying sustain pulses corresponding to the weight value of the plurality of subfields and driving the first and second electrodes,
wherein a third gray level, a fourth gray level that is lower than the third gray level, and a fifth gray level that is higher than the third gray level are mapped to the plurality of subfields, and
wherein when the number of subfields illuminated corresponding to the third gray level is smaller than the number of subfields illuminated corresponding to the fourth gray level and to the fifth gray level, the controller applies dithering to the fourth gray level and the fifth gray level to display the third gray level.
